(19) United States
(12) Patent Application Publication
(10) Pub. No.: US 2024/0014761 A1
(43) Pub. Date: Jan. 11, 2024

(54) MOTOR CONTROLLER

(71) Applicant: Global Mixed-mode Technology Inc., Hsin-Chu (TW)

(72) Inventor: Chi-Hong Su, Hsinchu City (TW)

(73) Assignee: Global Mixed-mode Technology Inc., Hsin-Chu (TW)

(21) Appl. No.: 17/859,031

(22) Filed: Jul. 7, 2022

(51) Int. Cl. H02P 27/08

(52) U.S. Cl. CPC H02P 27/085; H02P 2209/07; H02P 2209/11

(57) ABSTRACT

A motor controller comprises a switch circuit and a driving circuit. The switch circuit is coupled to a motor for driving the motor. The driving circuit generates a plurality of control signals to control the switch circuit. The motor controller is configured to crop a first waveform into a second waveform, where the first waveform is transformed into the second waveform gradually. Moreover, the motor controller is configured to transform the second waveform into the first waveform, where the second waveform is transformed into the first waveform gradually. The first waveform may be an M-shaped waveform, a W-shaped waveform, or a sinusoidal waveform. The second waveform may be a trapezoidal waveform.

### BACKGROUND OF THE INVENTION

### 1. Field of the Invention

The present invention relates to a motor controller, and more particularly, to a motor controller which may be applied to a single-phase sensorless motor or polyphase sensorless motor.

### 2. Description of the Prior Art

Conventionally, there are two driving methods for driving a motor. The first driving method uses the Hall sensor for switching phases, so as to drive the motor. The second driving method does not use the Hall sensor to drive the motor. The Hall sensor is affected by the external environment easily, such that the detecting accuracy is decreased. Besides, the installation of the Hall sensor results in an increase of the volume and the cost of the system. Therefore, the sensorless driving method is provided for solving the above problems.

In the sensorless driving method, the designer may utilize an M-shaped waveform, a W-shaped waveform, a sinusoidal waveform, or a trapezoidal waveform to drive the motor. However, different waveforms cannot coexist usually. Therefore, a new technology is needed to overcome this issue.

### SUMMARY OF THE INVENTION

According to the present invention, a motor controller which is capable of cropping a first waveform into a second waveform is provided, where the first waveform is transformed into the second waveform gradually. A shape of the first waveform is different from a shape of the second waveform. The motor controller may utilize a threshold value or a predetermined duty cycle to crop the first waveform into the second waveform, where the predetermined duty cycle may be a maximum duty cycle. The motor controller may crop the first waveform into the second waveform by comparing a stored value with the threshold value. The motor controller may crop the first waveform into the second waveform by comparing a first driving signal with the predetermined duty cycle. The threshold value may be an N-bit value, where N is a positive integer and N is greater than 1. For instance, the threshold value is an eight-bit value. The predetermined duty cycle may be an N-bit value, where N is a positive integer and N is greater than 1. For instance, the predetermined duty cycle is a ten-bit value. The motor controller may be configured to offer a user to set the threshold value, where the user may set the threshold value via a graphical user interface. Similarly, the motor controller may be configured to offer a user to set the predetermined duty cycle, where the user may set the predetermined duty cycle via a graphical user interface. Moreover, according to the present invention, the motor controller which is capable of transforming the second waveform into the first waveform is provided, where the second waveform is transformed into the first waveform gradually. When the motor controller is switched from a low speed mode to a high speed mode, the motor controller may be configured to transform the first waveform into the second waveform gradually. When the motor controller is switched from a high speed mode to a low speed mode, the motor controller may be configured to transform the second waveform into the first waveform gradually. The first waveform may be an M-shaped waveform, a W-shaped waveform, or a sinusoidal waveform. The second waveform may be a trapezoidal waveform. The motor controller may be configured to adjust a slope of the trapezoidal waveform or a height of the trapezoidal waveform. According to one embodiment of the present invention, the motor controller may crop the M-shaped waveform into the trapezoidal waveform, where the M-shaped waveform is transformed into the trapezoidal waveform gradually. The motor controller may utilize the same technology to crop the W-shaped waveform or the sinusoidal waveform into the trapezoidal waveform, where the W-shaped waveform or the sinusoidal waveform is transformed into the trapezoidal waveform gradually. According to one embodiment of the present invention, the motor controller may transform the trapezoidal waveform into the M-shaped waveform, where the trapezoidal waveform is transformed into the M-shaped waveform gradually. The motor controller may utilize the same technology to transform the trapezoidal waveform into the W-shaped waveform or the sinusoidal waveform, where the trapezoidal waveform is transformed into the W-shaped waveform or the sinusoidal waveform gradually.

The motor controller is configured to drive a motor. The motor may be a three-phase motor, where the motor has a first coil, a second coil, and a third coil. The motor controller comprises a switch circuit, a driving circuit, a pulse width modulation circuit, and a waveform-cropping circuit. The switch circuit includes a first transistor, a second transistor, a third transistor, a fourth transistor, a fifth transistor, a sixth transistor, a first terminal, a second terminal, and a third terminal, where the switch circuit is coupled to the motor for driving the motor. The first terminal, the second terminal, and the third terminal respectively provides a first driving signal, a second driving signal, and the third driving signal for driving the motor. The first driving signal may have the M-shaped waveform, the W-shaped waveform, the sinusoidal waveform, or the trapezoidal waveform. The second driving signal may have the M-shaped waveform, the W-shaped waveform, the sinusoidal waveform, or the trapezoidal waveform. The third driving signal may have the M-shaped waveform, the W-shaped waveform, the sinusoidal waveform, or the trapezoidal waveform. The first transistor is coupled to a fourth terminal and the first terminal while the second transistor is coupled to the first terminal and a fifth terminal. The third transistor is coupled to the fourth terminal and the second terminal while the fourth transistor is coupled to the second terminal and the fifth terminal. The fifth transistor is coupled to the fourth terminal and the third terminal while the sixth transistor is coupled to the third terminal and the fifth terminal. One terminal of the first coil is coupled to the first terminal. One terminal of the second coil is coupled to the second terminal. One terminal of the third coil is coupled to the third terminal. Furthermore, another terminal of the first coil is coupled to another terminal of the second coil and another terminal of the third coil. That is to say, the first coil, the second coil, and the third coil form a Y-shaped configuration. The driving circuit generates a first control signal, a second control signal, a third control signal, a fourth control signal, a fifth control signal, and a sixth control signal for respectively controlling the ON/OFF states of the first transistor, the second transistor, the third transistor, the fourth transistor, the fifth transistor, and the sixth transistor. The pulse width modulation circuit generates a pulse width modulation signal to the driving circuit, where the pulse width modulation signal has a duty cycle. The waveform-cropping circuit generates an output signal to the pulse width modulation circuit. The motor controller may control the speed of the motor by adjusting the duty cycle.

The waveform-cropping circuit comprises a multiplication circuit, a look-up table circuit, a gain circuit, and a speed control circuit. The multiplication circuit comprises a first multiplier and a second multiplier. The look-up table circuit comprises a pattern table. An M-shaped waveform driving mode, a W-shaped waveform driving mode, a sinusoidal waveform driving mode, or a trapezoidal waveform driving mode is utilized to drive the motor according to one purpose of the present invention. When the motor controller is operated at a low speed, the motor controller adopts the M-shaped waveform driving mode, the W-shaped waveform driving mode, or the sinusoidal waveform driving mode to reduce noise. When the motor controller is operated at a high speed, the motor controller adopts the trapezoidal waveform driving mode to supply a high power to the motor. More specifically, the motor controller may gradually transform the M-shaped waveform, the W-shaped waveform, or the sinusoidal waveform into the trapezoidal waveform to avoid entering an unstable state and reduce noise. The motor controller may gradually transform the trapezoidal waveform into the M-shaped waveform, the W-shaped waveform, or the sinusoidal waveform to avoid entering an unstable state and reduce noise. Besides, the motor controller may generate the first waveform and the second waveform by a single pattern table. Thus, the motor controller does not need to utilize two pattern tables for respectively generating the first waveform and the second waveform, thereby decreasing the chip area and reducing the manufacturing cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The above-mentioned and other objects, features, and advantages of the present invention will become apparent with reference to the following descriptions and accompanying drawings, wherein:

FIG. 1 is a schematic diagram showing a motor controller according to one embodiment of the present invention;

FIG. 2 is a schematic diagram showing a waveform-cropping circuit according to one embodiment of the present invention;

FIG. 3 is a waveform chart of the first driving signal according to the first embodiment of the present invention;

FIG. 4 is a waveform chart of the first driving signal according to the second embodiment of the present invention;

FIG. 5 is a waveform chart of the first driving signal according to the third embodiment of the present invention; and

FIG. 6 is a flow chart according to one embodiment of the present invention.

### DETAILED DESCRIPTION

Preferred embodiments according to the present invention will be described in detail with reference to the drawings.

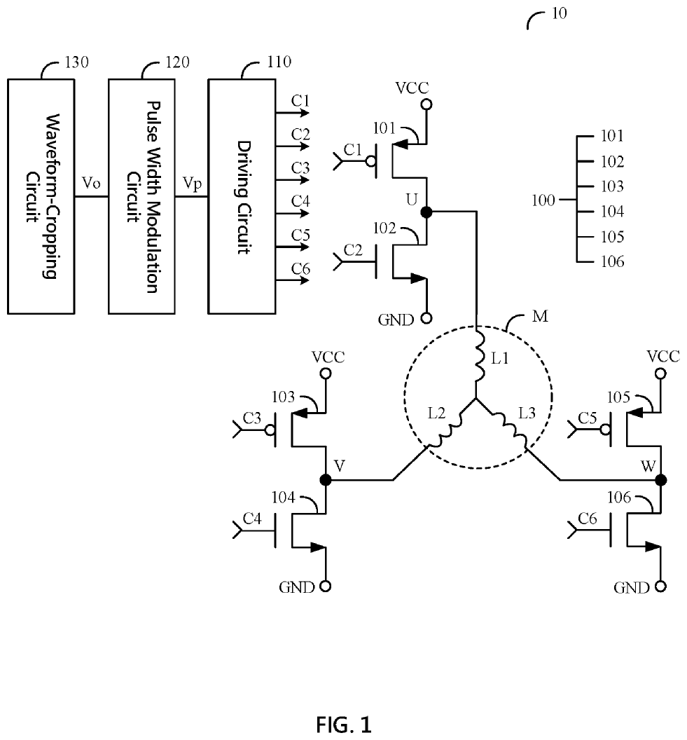

FIG. 1 is a schematic diagram showing a motor controller 10 according to one embodiment of the present invention. The motor controller 10 is used for driving a motor M. The motor M may be a three-phase motor, where the motor M has a first coil L1, a second coil L2, and a third coil L3. The motor controller 10 comprises a switch circuit 100, a driving circuit 110, a pulse width modulation circuit 120, and a waveform-cropping circuit 130. The switch circuit 100 includes a first transistor 101, a second transistor 102, a third transistor 103, a fourth transistor 104, a fifth transistor 105, a sixth transistor 106, a first terminal U, a second terminal V, and a third terminal W, where the switch circuit 100 is coupled to the motor M for driving the motor M. The first terminal U, the second terminal V, and the third terminal W respectively provides a first driving signal Su, a second driving signal Sv, and the third driving signal Sw for driving the motor M. The first transistor 101 is coupled to a fourth terminal VCC and the first terminal U while the second transistor 102 is coupled to the first terminal U and a fifth terminal GND. The third transistor 103 is coupled to the fourth terminal VCC and the second terminal V while the fourth transistor 104 is coupled to the second terminal V and the fifth terminal GND. The fifth transistor 105 is coupled to the fourth terminal VCC and the third terminal W while the sixth transistor 106 is coupled to the third terminal W and the fifth terminal GND. Each of the first transistor 101, the third transistor 103, and the fifth transistor 105 may be a p-type MOSFET. Each of the second transistor 102, the fourth transistor 104, and the sixth transistor 106 may be an n-type MOSFET.

One terminal of the first coil L1 is coupled to the first terminal U. One terminal of the second coil L2 is coupled to the second terminal V. One terminal of the third coil L3 is coupled to the third terminal W. Furthermore, another terminal of the first coil L1 is coupled to another terminal of the second coil L2 and another terminal of the third coil L3. That is to say, the first coil L1, the second coil L2, and the third coil L3 form a Y-shaped configuration. The driving circuit 110 generates a first control signal C1, a second control signal C2, a third control signal C3, a fourth control signal C4, a fifth control signal C5, and a sixth control signal C6 for respectively controlling the ON/OFF states of the first transistor 101, the second transistor 102, the third transistor 103, the fourth transistor 104, the fifth transistor 105, and the sixth transistor 106. The pulse width modulation circuit 120 generates a pulse width modulation signal Vp to the driving circuit 110, where the pulse width modulation signal Vp has a duty cycle. The waveform-cropping circuit 130 generates an output signal Vo to the pulse width modulation circuit 120. The motor controller 10 may control the speed of the motor M by adjusting the duty cycle.

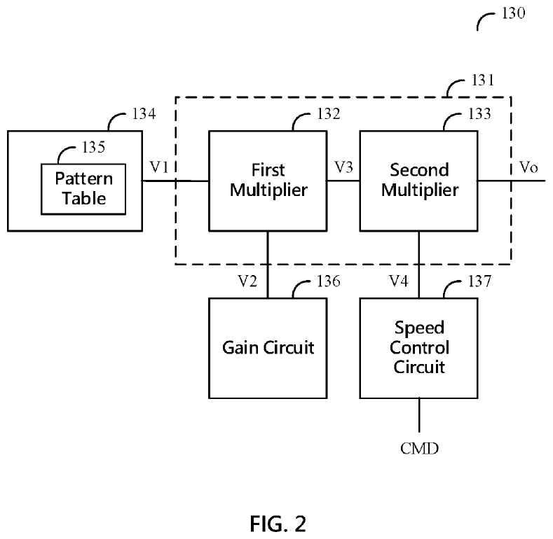

FIG. 2 is a schematic diagram showing the waveform-cropping circuit 130 according to one embodiment of the present invention. The waveform-cropping circuit 130 comprises a multiplication circuit 131, a look-up table circuit 134, a gain circuit 136, and a speed control circuit 137. The multiplication circuit 131 comprises a first multiplier 132 and a second multiplier 133. The look-up table circuit 134 comprises a pattern table 135. An M-shaped waveform driving mode, a W-shaped waveform driving mode, a sinusoidal waveform driving mode, or a trapezoidal waveform driving mode is utilized to drive the motor M according to one purpose of the present invention. When the motor controller 10 is operated at a low speed, the motor controller 10 adopts the M-shaped waveform driving mode, the W-shaped waveform driving mode, or the sinusoidal waveform driving mode to reduce noise. When the motor controller 10 is operated at a high speed, the motor controller 10 adopts the trapezoidal waveform driving mode to supply a high power to the motor M. The motor controller 10 may crop an M-shaped waveform, a W-shaped waveform, or a sinusoidal waveform into a trapezoidal waveform by the waveform-cropping circuit 130. Similarly, the motor controller 10 may transform the trapezoidal waveform into the M-shaped waveform, the W-shaped waveform, or the sinusoidal waveform. More specifically, the motor controller 10 may gradually transform the M-shaped waveform, the W-shaped waveform, or the sinusoidal waveform into the trapezoidal waveform to avoid entering an unstable state and reduce noise. The motor controller 10 may gradually transform the trapezoidal waveform into the M-shaped waveform, the W-shaped waveform, or the sinusoidal waveform to avoid entering an unstable state and reduce noise. In order to meet the above requirements, there are at least three embodiments as follows:

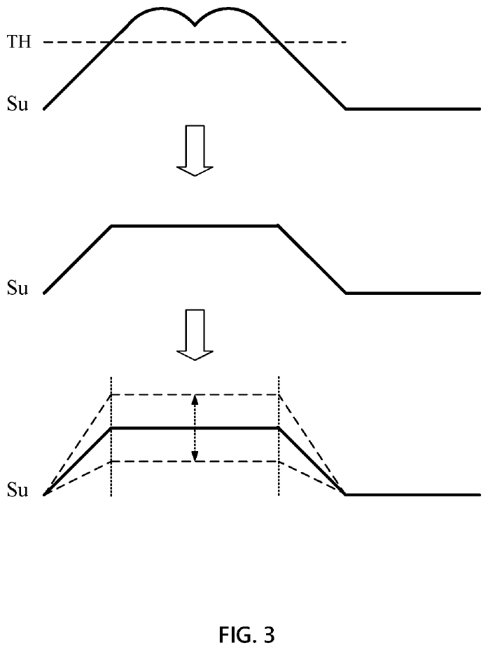

1. FIG. 3 is a waveform chart of the first driving signal Su according to the first embodiment of the present invention, where the first driving signal Su has the M-shaped waveform. Please refer to FIG. 2 and FIG. 3 simultaneously. First of all, the motor controller 10 gets a stored value S of the pattern table 135, where the stored value S is related to the first driving signal Su. The motor controller 10 may utilize a threshold value TH to crop the M-shaped waveform into the trapezoidal waveform, where the threshold value TH may store in the look-up table circuit 134. Then the motor controller 10 judges if the stored value S is greater than the threshold value TH or not. When the stored value S is greater than the threshold value TH, the threshold value TH is outputted and the threshold value TH may be represented by a first signal V1. When the stored value S is less than the threshold value TH, the stored value S is outputted and the stored value S may be represented by the first signal V1. The look-up table circuit 134 is configured to generate the first signal V1 to the multiplication circuit 131. As shown in FIG. 3, the M-shaped waveform is cropped into the trapezoidal waveform by the threshold value TH. The gain circuit 136 is configured to generate a second signal V2 to the multiplication circuit 131. The second signal V2 may represent a gain value G, where the gain value G may be a normalized gain. The first multiplier 132 receives the first signal V1 and the second signal V2, so as to generate a third signal V3 to the second multiplier 133. The first multiplier 132 is configured to perform a multiplication based on the first signal V1 and the second signal V2. As shown in FIG. 3, when the gain value G is greater than 1, the trapezoidal waveform becomes larger. When the gain value G is less than 1, the trapezoidal waveform becomes smaller. That is, the motor controller 10 may adjust the slope of the trapezoidal waveform and the height of the trapezoidal waveform by the gain value G. The speed control circuit 137 receives a command signal CMD, so as to generate a fourth signal V4 to the multiplication circuit 131, where the command signal CMD may be a pulse width modulation signal. The command signal CMD relates to a motor speed. The fourth signal V4 may represent a speed control value R. The second multiplier 133 receives the third signal V3 and the fourth signal V4 to generate the output signal Vo. The second multiplier 133 is configured to perform a multiplication based on the third signal V3 and the fourth signal V4. Lastly, the pulse width modulation circuit 120 receives the output signal Vo, so as to generate the pulse width modulation signal Vp to drive the motor M. The stored value S may be an N-bit value, where N is a positive integer and N is greater than 1. Also, the threshold value TH may be an N-bit value. Each of the first signal V1 and the second signal V2 may be an N-bit digital signal. For example, N may be equal to 8. When N is equal to 8, each of the third signal V3 and the fourth signal V4 may be a ten-bit digital signal. The motor controller 10 may offer the user to set the output signal Vo to be an eight-bit digital signal, a nine-bit digital signal, or a ten-bit digital signal, where the user may select the bit number of the output signal Vo by a graphical user interface. In other words, the motor controller 10 may offer the user to set the bit number utilized to represent the M-shaped waveform and the trapezoidal waveform via the graphical user interface. Furthermore, the motor controller 10 may offer the user to set the threshold value TH, too. The motor controller 10 may offer the user to set the threshold value TH via the graphical user interface. The user may select the threshold value TH according to the motor structure.

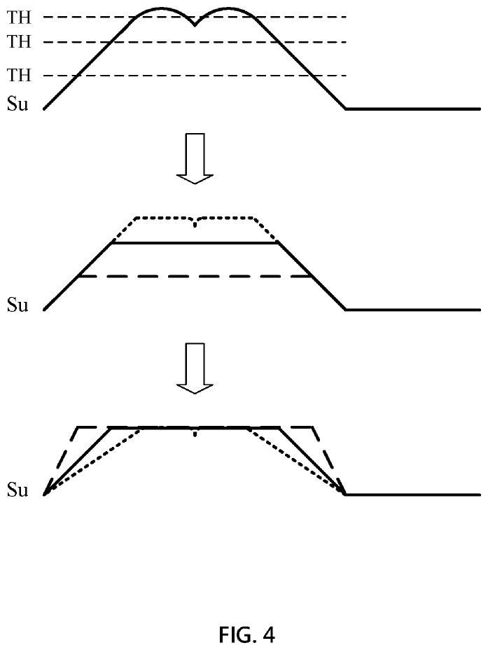

2. FIG. 4 is a waveform chart of the first driving signal Su according to the second embodiment of the present invention, where the first driving signal Su has the M-shaped waveform. Please refer to FIG. 2 and FIG. 4 simultaneously. First of all, the motor controller 10 gets a stored value S of the pattern table 135, where the stored value S is related to the first driving signal Su. Then the motor controller 10 judges if the stored value S is greater than the threshold value TH or not. When the stored value S is greater than the threshold value TH, the threshold value TH is outputted. When the stored value S is less than the threshold value TH, the stored value S is outputted. The first signal V1 may represent the stored value S or the threshold value TH. Moreover, the user may select the different threshold value TH for cropping the different size of trapezoidal waveform via the graphical user interface. As shown in FIG. 4, when the threshold value TH increases, the size of the trapezoidal waveform increases. When the threshold value TH decreases, the size of the trapezoidal waveform decreases. The gain circuit 136 is configured to generate the second signal V2 to the multiplication circuit 131, where the second signal V2 may represent the gain value G. The first multiplier 132 receives the first signal V1 and the second signal V2 to generate the third signal V3. The motor controller 10 may select the corresponding gain value G according to the threshold value TH. For example, when the threshold value TH increases, the gain value G decreases. That is, the gain value G may be inversely proportional to the threshold value TH and the gain value G may be the normalized gain. Lastly, different trapezoidal waveforms may respectively have different slopes and the same height. Therefore, the motor controller 10 may offer the user to set the threshold value TH and the slope of the trapezoidal waveform via the graphical user interface. The second multiplier 133 receives the third signal V3 and the fourth signal V4 to generate the output signal Vo, where the fourth signal V4 may be configured to represent the speed control value R. The pulse width modulation circuit 120 receives the output signal Vo, so as to generate the pulse width modulation signal Vp to drive the motor M.

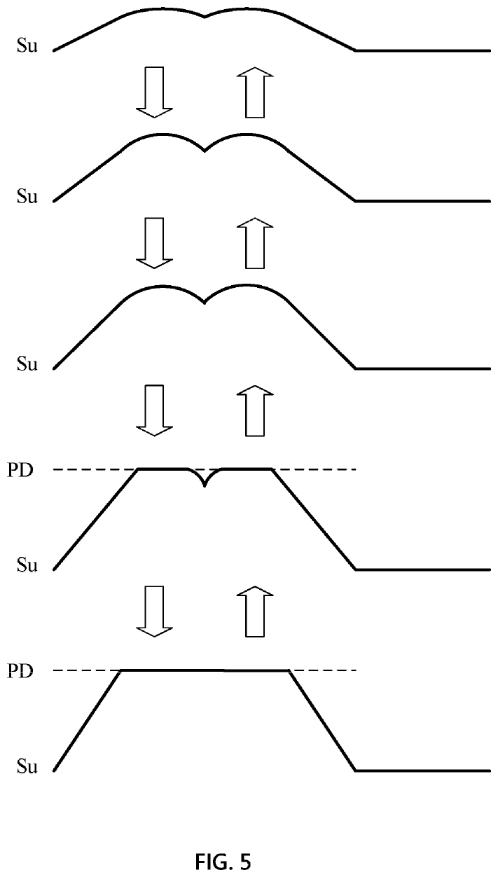

3. FIG. 5 is a waveform chart of the first driving signal Su according to the third embodiment of the present invention, where the first driving signal Su has the M-shaped waveform. Please refer to FIG. 2 and FIG. 5 simultaneously. First of all, the motor controller 10 gets a stored value S of the pattern table 135, where the stored value S is related to the first driving signal Su. The motor controller 10 may utilize a predetermined duty cycle PD to transform the M-shaped waveform into the trapezoidal waveform gradually, where the predetermined duty cycle PD may be a maximum duty cycle. The predetermined duty cycle PD may be an N-bit value, where N is a positive integer and N is greater than 1. For instance, the predetermined duty cycle PD may be a ten-bit value. Since it is needless to utilize the threshold value TH in the third embodiment, the first signal V1 may represent the stored value S directly. When the speed control value R increases gradually according to the command signal CMD, the motor speed increases gradually. As shown in FIG. 5, at this moment the M-shaped waveform is enlarged gradually. When the first driving signal Su is greater than the predetermined duty cycle PD, the first driving signal Su is fixed at the predetermined duty cycle PD by the motor controller 10. Lastly, the motor controller 10 may transform the M-shaped waveform into the trapezoidal waveform gradually, so as to avoid entering an unstable state and reduce noise. On the contrary, when the speed control value R decreases gradually according to the command signal CMD, the motor speed decreases gradually. As shown in FIG. 5, the motor controller 10 may transform the trapezoidal waveform into the M-shaped waveform gradually, so as to avoid entering an unstable state and reduce noise. Besides, the gain value G may be configured to determine that the first driving signal Su achieves the predetermined duty cycle PD in a faster or slower way. The user may select the gain value G and the predetermined duty cycle PD according to the motor structure. Similarly, the motor controller 10 may offer the user to set the gain value G and the predetermined duty cycle PD via the graphical user interface.

When the first driving signal Su has a W-shaped waveform, the motor controller 10 may crop the W-shaped waveform into a trapezoidal waveform by the above technology, where the W-shaped waveform is transformed into the trapezoidal waveform gradually. The motor controller 10 may transform the trapezoidal waveform into the W-shaped waveform, where the trapezoidal waveform is transformed into the W-shaped waveform gradually. A detailed process is not described herein again. Likewise, when the first driving signal Su has a sinusoidal waveform, the motor controller 10 may crop the sinusoidal waveform into a trapezoidal waveform by the above technology as well, where the sinusoidal waveform is transformed into the trapezoidal waveform gradually. The motor controller 10 may transform the trapezoidal waveform into the sinusoidal waveform, where the trapezoidal waveform is transformed into the sinusoidal waveform gradually. A detailed process is not described herein again.

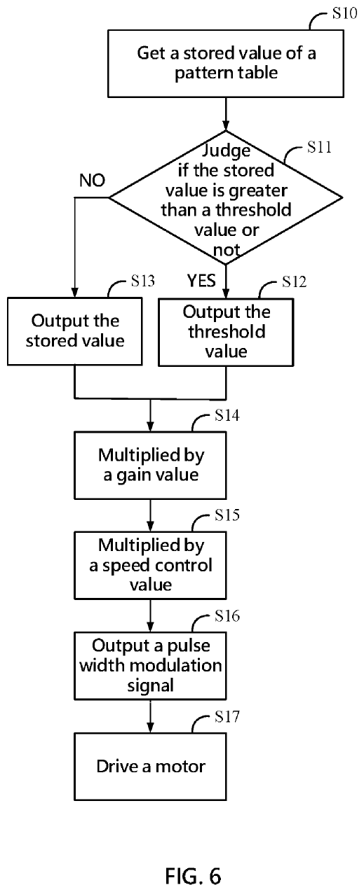

FIG. 6 is a flow chart according to one embodiment of the present invention. First of all, the motor controller 10 gets a stored value S of the pattern table 135 (Step S10), where the stored value S is related to the first driving signal Su. Then the motor controller 10 judges if the stored value S is greater than a threshold value TH or not (Step S11). When the stored value S is greater than the threshold value TH, the threshold value TH is outputted (Step S12). When the stored value S is less than the threshold value TH, the stored value S is outputted (Step S13). If the motor controller 10 does not utilize the threshold value TH (e.g., the third embodiment) to switch waveforms, the motor controller 10 may skip Step S11 and Step S12 and output the stored value S directly. The first signal V1 may represent the threshold value TH or the stored value S. Then the motor controller 10 is configured to multiply a gain value G (Step S14) by the threshold value TH or the stored value S. The second signal V2 may represent the gain value G. The first multiplier 132 may be configured to perform the multiplication and generate the third signal V3. Then the motor controller 10 is configured to multiply a speed control value R (Step S15) by the third signal V3. The fourth signal V4 may represent the speed control value R. The second multiplier 133 may be configured to perform the multiplication and generate the output signal Vo. Then the motor controller 10 is configured to output a pulse width modulation signal Vp (Step S16) based on the output signal Vo. Lastly, the motor controller 10 adjusts the speed of the motor M and drives the motor M (Step S17) based on the pulse width modulation signal Vp.

According to one embodiment of the present invention, the motor controller 10 may be applied to a single-phase motor, a polyphase motor, a brushed motor, a brushless motor, or a DC motor. The motor controller 10 may gradually transform the M-shaped waveform, the W-shaped waveform, or the sinusoidal waveform into the trapezoidal waveform to avoid entering an unstable state and reduce noise. The motor controller 10 may gradually transform the trapezoidal waveform into the M-shaped waveform, the W-shaped waveform, or the sinusoidal waveform to avoid entering an unstable state and reduce noise. Furthermore, the motor controller 10 may generate different waveforms by a single pattern table 135, so as to decrease the chip area and reduce the manufacturing cost.

While the present invention has been described by the preferred embodiments, it is to be understood that the invention is not limited to the disclosed embodiments. On the contrary, it is intended to cover various modifications. Therefore, the scope of the appended claims should be accorded the broadest interpretation so as to encompass all such modifications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motor controller, wherein the motor controller is configured to drive a motor, and the motor controller comprising:
a switch circuit, coupled to the motor for driving the motor; and
a driving circuit, configured to generate a plurality of control signals to control the switch circuit, wherein the motor controller is configured to crop a first waveform into a second waveform, and the first waveform is transformed into the second waveform gradually.

2. The motor controller of claim 1, wherein the first waveform is an M-shaped waveform.

3. The motor controller of claim 1, wherein the first waveform is a W-shaped waveform.

4. The motor controller of claim 1, wherein the first waveform is a sinusoidal waveform.

5. The motor controller of claim 1, wherein the second waveform is a trapezoidal waveform.

6. The motor controller of claim 5, wherein the motor controller is configured to adjust a slope of the trapezoidal waveform.

7. The motor controller of claim 5, wherein the motor controller is configured to adjust a height of the trapezoidal waveform.

8. The motor controller of claim 1, wherein the motor controller utilizes a threshold value to crop the first waveform into the second waveform.

9. The motor controller of claim 8, wherein the motor controller is configured to offer a user to set the threshold value.

10. The motor controller of claim 9, wherein the user sets the threshold value via a graphical user interface.

11. The motor controller of claim 8, wherein the motor controller is configured to crop the first waveform into the second waveform by comparing a stored value with the threshold value.

12. The motor controller of claim 8, wherein the threshold value is an N-bit value, N is a positive integer, and N is greater than 1.

13. The motor controller of claim 12, wherein N is equal to 8.

14. The motor controller of claim 1, wherein the motor controller utilizes a predetermined duty cycle to crop the first waveform into the second waveform.

15. The motor controller of claim 14, wherein the motor controller is configured to offer a user to set the predetermined duty cycle.

16. The motor controller of claim 15, wherein the user sets the predetermined duty cycle via a graphical user interface.

17. The motor controller of claim 14, wherein the predetermined duty cycle is a maximum duty cycle.

18. The motor controller of claim 14, wherein the motor controller is configured to crop the first waveform into the second waveform by comparing a first driving signal with the predetermined duty cycle.

19. The motor controller of claim 14, wherein the predetermined duty cycle is an N-bit value, N is a positive integer, and N is greater than 1.

20. The motor controller of claim 19, wherein N is equal to 10.

21. The motor controller of claim 1, wherein the motor controller generates the first waveform and the second waveform by a single pattern table.

22. The motor controller of claim 1, wherein the motor controller is configured to transform the second waveform into the first waveform, and the second waveform is transformed into the first waveform gradually.

23. The motor controller of claim 1, wherein the switch circuit comprises:
a first transistor, coupled to a fourth terminal and a first terminal;
a second transistor, coupled to a fifth terminal and the first terminal;
a third transistor, coupled to the fourth terminal and a second terminal;
a fourth transistor, coupled to the fifth terminal and the second terminal;
a fifth transistor, coupled to the fourth terminal and a third terminal; and
a sixth transistor, coupled to the fifth terminal and the third terminal.

24. The motor controller of claim 23, wherein the first terminal provides a first driving signal for driving the motor, and the first driving signal has the first waveform.

25. The motor controller of claim 23, wherein the first terminal provides a first driving signal for driving the motor, and the first driving signal has the second waveform.

26. The motor controller of claim 1, wherein the motor controller is applied to a single-phase motor.

27. The motor controller of claim 1, wherein the motor controller is applied to a polyphase motor.

28. The motor controller of claim 1, wherein the motor controller is applied to a brushed motor.

29. The motor controller of claim 1, wherein the motor controller is applied to a brushless motor.

30. The motor controller of claim 1, wherein the motor controller is applied to a DC motor.

31. The motor controller of claim 1, wherein the motor controller further comprises a pulse width modulation circuit, and the pulse width modulation circuit generates a pulse width modulation signal to the driving circuit.

32. The motor controller of claim 31, wherein the motor controller further comprises a waveform-cropping circuit, and the waveform-cropping circuit generates an output signal to the pulse width modulation circuit.

33. The motor controller of claim 32, wherein the waveform-cropping circuit comprises a multiplication circuit, and the multiplication circuit generates the output signal.

34. The motor controller of claim 33, wherein the waveform-cropping circuit further comprises a look-up table circuit, and the look-up table circuit generates a first signal to the multiplication circuit.

35. The motor controller of claim 34, wherein the waveform-cropping circuit further comprises a gain circuit, and the gain circuit generates a second signal to the multiplication circuit.

36. The motor controller of claim 35, wherein the multiplication circuit comprises a first multiplier and a second multiplier, and the first multiplier receives the first signal and the second signal, so as to generate a third signal to the second multiplier.

37. The motor controller of claim 36, wherein the waveform-cropping circuit further comprises a speed control circuit, and the speed control circuit receives a command signal, so as to generate a fourth signal to the multiplication circuit.

38. The motor controller of claim 37, wherein the second multiplier receives the third signal and the fourth signal to generate the output signal.

39. A motor controller, wherein the motor controller is configured to drive a motor, and the motor controller comprising:
a switch circuit, coupled to the motor for driving the motor; and
a driving circuit, configured to generate a plurality of control signals to control the switch circuit, wherein when the motor controller is switched from a low speed mode to a high speed mode, the motor controller is configured to transform a first waveform into a second waveform gradually, and a shape of the first waveform is different from a shape of the second waveform.

40. The motor controller of claim 39, wherein the first waveform is an M-shaped waveform.

41. The motor controller of claim 39, wherein the first waveform is a W-shaped waveform.

42. The motor controller of claim 39, wherein the first waveform is a sinusoidal waveform.

43. The motor controller of claim 39, wherein the second waveform is a trapezoidal waveform.

44. A motor controller, wherein the motor controller is configured to drive a motor, and the motor controller comprising:
a switch circuit, coupled to the motor for driving the motor; and
a driving circuit, configured to generate a plurality of control signals to control the switch circuit, wherein when the motor controller is switched from a high speed mode to a low speed mode, the motor controller is configured to transform a second waveform into a first waveform gradually, and a shape of the first waveform is different from a shape of the second waveform.

45. The motor controller of claim 44, wherein the first waveform is an M-shaped waveform.

46. The motor controller of claim 44, wherein the first waveform is a W-shaped waveform.

47. The motor controller of claim 44, wherein the first waveform is a sinusoidal waveform.

48. The motor controller of claim 44, wherein the second waveform is a trapezoidal waveform.
